(19) United States
(12) Patent Application Publication
(10) Pub. No.: US 2008/0206610 A1
(43) Pub. Date: Aug. 28, 2008

(54) Method of Operating an Electrochemical Device Including Mass Flow and Electrical Parameter Controls

(76) Inventors: James H. Saunders, Worthington, OH (US); Bradley C. Glenn, Hilliard, OH (US); Chad M. Cucksey, Columbus, OH (US)

Correspondence Address: BATTELLE MEMORIAL INSTITUTE, 505 KING AVENUE, COLUMBUS, OH, 43201-2693, US

(21) Appl. No.: 12/088,476

(22) PCT Filed: Sep. 30, 2005
(86) PCT No.: PCT/US2006/038398

§ 371 Date: Mar. 28, 2008

Related U.S. Application Data
(60) Provisional application No. 60/722,214, filed on Sep. 30, 2005.

(51) Int. Cl. H01M 8/04

(52) U.S. Cl. 429/13

(57) ABSTRACT

This invention relates to a method of operating an electrochemical device. The method includes controlling the mass flow of fuel to the device so that the mass flow varies during the operation of the device. In combination with the mass flow control, the method also includes controlling an electrical parameter of the device so that the electrical parameter varies during the operation of the device. Another embodiment includes a method of operating a fuel cell using a flow of fuel or oxidant that contains a contaminant, and using a controller to control the flow and an electrical parameter of the fuel cell. A further embodiment includes a method of operating an electrochemical device using reactants that include a reactant causing an undesired electrochemical reaction, and using a controller to control the flow of reactants and an electrical parameter of the device.

### CROSS-REFERENCE TO RELATED APPLICATIONS

This application claims the benefit of U.S. Provisional Application No. 60/722,214, filed Sep. 30, 2005, the disclosure of which is incorporated herein by reference. The invention also includes some of the methods described in International Publication No. WO 03/067696 A2, which is referred to at various locations in the description. Some relevant portions of this international publication are included herein after the examples. The corresponding U.S. patent application Ser. No. 10/913,287, filed Aug. 6, 2004, is incorporated by reference herein.

### BACKGROUND OF THE INVENTION

This invention relates in general to electrochemical devices, and in particular to a method of operating an electrochemical device by controlling certain parameters of the device.

U.S. Pat. No. 6,896,982 by Jia et al. discloses in the Background section that the negative effects of CO contamination of an anode catalyst of a fuel cell can be reversed using electrical and/or fuel starvation techniques. In the Summary section, the patent states that shorting and/or starvation techniques may be used along with the conditioning method of the invention.

U.S. Pat. No. 6,096,448 by Wilkinson et al. discloses a method of removing poisons from the anode of a fuel cell by periodic momentary fuel starvation at the anode. There is no suggestion in the patent to use voltage controls to raise the overvoltage at the anode.

US Patent Application 2003/0211372 A1 by Adams et al. discloses the use of voltage pulsing to remove poisons from an anode of a fuel cell. In the Background section, the application refers to U.S. Pat. No. 6,096,448 (fuel starvation at the anode).

US Patent Application 2004/0224192 A1 by Pearson discloses the use of current pulsing to improve fuel cell performance. In the Background section, the application refers to the above-described U.S. Pat. No. 6,096,448 (fuel starvation at the anode).

U.S. Pat. No. 6,841,278 by Reiser et al. discloses a method of improving fuel cell performance by cyclic oxidant starvation at the anode.

The prior art has not shown the combined use of mass flow and current or voltage controls in a sophisticated manner to improve the operation of an electrochemical device.

### SUMMARY OF THE INVENTION

In one embodiment, the invention relates to a method of operating an electrochemical device. The method includes controlling the mass flow of fuel to the device so that the mass flow varies during the operation of the device. In combination with the mass flow control, the method also includes controlling an electrical parameter of the device so that the electrical parameter varies during the operation of the device.

In another embodiment, the invention relates to a method of operating a fuel cell comprising: a) applying a time-varying amplitude of a flow of fuel or oxidant to an anode or cathode of the fuel cell, the fuel or oxidant containing a contaminant; b) applying at least one time-varying electrical parameter to the entire fuel cell, individual cells or groups of cells, where the parameter includes at least one of current, voltage, electrode overvoltage, and impedance; and c) using a controller to control the timing and the time-varying amplitude of the flow and the at least one electrical parameter to maximize a performance measure of the fuel cell.

In a further embodiment, the invention relates to a method of operating an electrochemical device comprising: a) applying a time-varying and amplitude-varying flow of reactants to an anode or a cathode of the device, the reactants including a reactant that causes an undesired electrochemical reaction or adsorption onto the anode or cathode; b) applying at least one time-varying electrical parameter to the entire device, individual cells or groups of cells, where the parameter includes at least one of current, voltage, electrode overvoltage, and impedance; and c) using a controller to control the timing and the time-varying amplitude of the flow and the at least one electrical parameter to maximize a performance measure of the electrochemical device.

Various aspects of this invention will become apparent to those skilled in the art from the following detailed description of the preferred embodiments, when read in light of the accompanying drawings.

### BRIEF DESCRIPTION OF THE DRAWINGS

FIG. 1a shows a plot of voltage versus current for a fuel cell operated under three different conditions relating to the fuel: (a) pure hydrogen in a conventional manner, (b) 500 ppm CO in hydrogen in a steady flow, conventional manner, and (c) mass flow controls using 500 ppm CO in hydrogen as discussed in the text.

FIGS. 1b and 1c show plots of cell voltage and anode fuel flow of a fuel cell as a function of time.

FIG. 2 shows plots of cell voltage as a function of current for a fuel cell operated with 10% CO in hydrogen and with pure hydrogen at 70 C as the fuel and including different mass flow and voltage conditions.

FIG. 3 shows plots of voltage versus time for a fuel cell operated using hydrogen at 70 C with 10% CO for mass flow and current controls compared to mass flow alone.

FIG. 4 shows plots of voltage versus current for a 5 cm² fuel cell operated at 70 C using pure hydrogen, and operated at 70 C using 1% CO in hydrogen and mass flow and current controls according to the invention.

FIG. 5 shows plots of the analytical predictions of the power delivered by a fuel cell for two cases of variation of overvoltage as a function of time; and more specifically the running average of power from a simulated fuel cell operated as a half cell for two cases: an optimized waveform and rectangular pulsing.

FIG. 6 shows plots of the average power delivered by a fuel cell for three cases: (1) pure hydrogen, (2) an optimized waveform obtained with dynamic programming, and (3) rectangular pulsing.

### DETAILED DESCRIPTION OF THE PREFERRED EMBODIMENT

The present invention relates to a method of operating an electrochemical device which includes controlling the mass flow of fuel to the device so that the mass flow varies during the operation of the device, in combination with controlling an electrical parameter of the device so that the electrical parameter varies during the operation of the device.

In the description below we refer to a waveform. This can be any and all combinations of current, voltage, overvoltage, or fuel flow waveform or any other function of fundamental variables that are used to control the fuel cell. These are the control variables. The measured variables may also be any and all combinations of the above variables, including the control variables. The electrochemical system includes a fuel cell as a preferred system. The fuel cell discussion is focused on the anode, which has hydrogen (the fuel) and carbon monoxide (the poison) reacting. We seek to control the reaction rates to maximize a performance measure of the fuel cell. By analogy, the fuel cell can be generalized to an electrochemical system, where one desired component (analogous to hydrogen) is reacting on an electrode in the presence of a competing undesired component (analogous to carbon monoxide). Therefore in the description below, fuel cell can be generalized to electrochemical system, hydrogen can be generalized to one or more desired reacting species, which we refer to simply as the fuel, and carbon monoxide can be generalized to one or more undesired reacting species, which we refer to simply as the contaminant. The control techniques can be applied to an isolated electrochemical cell or to individual cells within a stack of cells or to groups of cells within a stack of cells. The techniques can also be applied to other electrochemical devices other than fuel cells, such as electrochemical sensors. The following description and claims describe applying an overvoltage to an electrode of the device. It should be noted that the overvoltage may be applied either directly by an electrical circuit or indirectly by varying one of the electrical parameters of the device.

Although we refer to mass flow controls in combination with electrical parameter controls, we also include the option of applying the techniques to mass flow controls without electrical parameter controls, or to electrical parameter controls without mass flow controls. In these cases, we may choose to measure the electrical and mass flow parameters but to control only one.

In one embodiment, the method enables the operation of an electrochemical device, such as a fuel cell, with a fuel or oxygen containing a level of an electrocontaminant, such as CO, that would ordinarily poison the cell significantly. For example, the level of contaminant may be at least about 100% higher than the same device operated without the mass flow and electrical parameter controls. With CO, conventional operation might be at 50 ppm CO, and the mass flow and electrical parameter controls might allow operation at 100 ppm or higher. Examples will be shown with operation at CO levels of up to 10% CO in hydrogen.

In one embodiment, the waveform of the cell voltage (and thus the power delivery and cell efficiency) can be improved dramatically if current or voltage controls are combined with the mass flow controls.

In one embodiment, mass flow and voltage or current can be independent variables in a multi-variable control strategy to optimize performance. The invention can enable operation at high CO concentrations or at low catalyst loadings. For example, the device may include a catalyst loaded on an electrode, and the device is operated with a loading of the catalyst that is at least about 25% lower than the same device operated without the mass flow and electrical parameter controls. An example will show that substantially improved performance is possible with optimal control theory applied to optimize performance.

The invention is related in particular to PEM fuel cells, but it may be applicable to other electrochemical devices and fuel cells by a person skilled in the art.

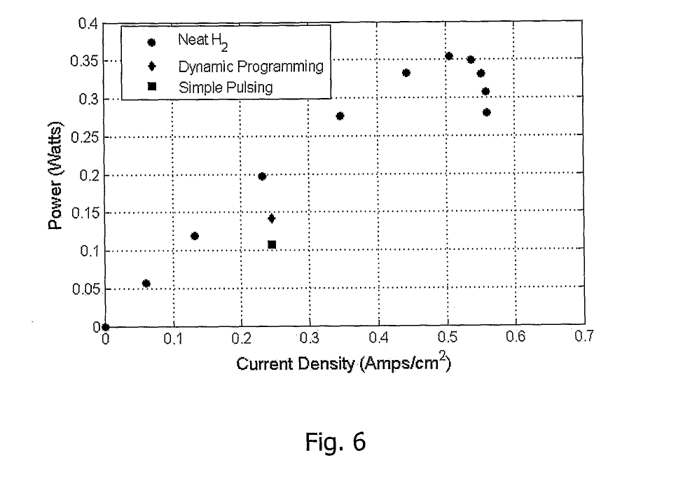

A typical measure of performance of a fuel cell is the average power delivered at a given current. For a cell operating with mass flow, current or voltage controls, this average power may be compared to the power from a cell operating with pure hydrogen on the anode. Conventional cells with a Pt—Ru catalyst on the anode, Pt on the cathode and 50 ppm in the hydrogen fuel produced about 60 to 80 percent of the power when the same fuel cell uses pure hydrogen in a study by Lee et al. [Electrochimica Acta 44 (1999) 3283-3293, FIG. 6]. A similar measure of performance compares the average voltage to the average current of the device in a curve known as the polarization curve.

To clean carbon monoxide from the anode of a PEM fuel cell, the anodic overvoltage must be raised to a sufficient value to oxidize the CO. Since less power is typically delivered during this cleaning process, and the time at the cleaning voltages is critical, the waveform can be optimized to deliver more power.

Controls for CO tolerance can be made more effective by operating the fuel cell in an inherently unsteady manner. In one embodiment, the fuel is pulsed into the cell, oxidized until the cell voltage begins to drop, and then additional fuel is pulsed into the cell. The cell voltage appears to drop because (in addition to other losses) the anodic overvoltage is increasing to oxidize the remaining fuel. When the overvoltage reaches the CO oxidation voltage, the anode is cleaned. Furthermore, the oxidation voltage appears to be reduced when the flow is stopped, possibly because the adsorption of CO onto the anode is reduced without flow.

In one embodiment of the invention, the following steps are included. (1) A fuel cell is used that has voltage controls as described in WO 03/067696 A2. That is, an electrical circuit is used to momentarily reduce the cell voltage and simultaneously raise the anode overvoltage. (2) During, just before or just after the overvoltage is raised, the mass flow of fuel to the anode is reduced. (3) After time sufficient to clean a major amount of contaminant from the device, the mass flow and the cell voltage return to their normal values for power production. (4) Steps 1 to 3 are repeated as needed, typically periodically every few seconds. In (3), the time for cleaning can be estimated by examining the cell voltage just after the cleaning step. The voltage should rise to 70 to 100% of the cell voltage corresponding to the pure hydrogen cell voltage at that current.

In another embodiment, the following steps are included. (1) The fuel enters the cell when a valve is opened for a specified time and is then closed, stopping the flow. (2) When the voltage drops below a specified value the valve is opened again for a specified time, introducing another pulse of flow into the cell. (3) At another specified time, the cell current is increased from a lower level to a higher level, increasing the anodic overvoltage further. (4) When the flow is reintroduced into the cell, and the electrode is cleaned (as defined above), the cell voltage increases. (5) At a specified voltage level the current is decreased to the lower level. (6) When the voltage reaches a specified level, the flow is again stopped. (7) The steps 2 through 6 are repeated periodically, typically from a few seconds to tens of seconds. The combined technique has the surprising result of increasing the power or average cell voltage to a much higher level than either mass flow or current or voltage controls alone, especially with high levels of carbon monoxide in the fuel.

The timing of the mass flow shutoff and the imposition of the cleaning (high) current may be varied to optimize a measure of the performance of the device. This includes the time that the mass flow is off, the time that the current is high, the time between initiation of the mass flow shutoff and the imposition of the cleaning current, and the repetition time.

The timing of these variables may optimize the process. For example, the anodic overvoltage required to oxidize CO to CO₂ increases as the partial pressure of CO₂ over the anode increases. Consequently, stopping the flow can reduce the partial pressure of CO and decrease the overvoltage required for cleaning, and thus reduce the power loss to the cell. In addition, once the cell is cleaned, if the flow is restarted the hydrogen appears to adsorb onto the anode faster than the CO, so initially there is a large current on the clean surface. Eventually, the CO covers the surface and the cell voltage decreases. Consequently, there is a time after the flow is restarted when there is a larger hydrogen current on the anode. Increasing the anodic current can aid in increasing the overvoltage in a controlled manner, and hasten the cleaning process, minimizing the time that power is lost.

Imposed variation in current, voltage, impedance or other circuit parameter or combinations can be used as independent variable(s) in addition to mass flow to control the system.

In another embodiment of the invention, a feedback control system is used that includes voltage controls to control one measure of performance and mass flow controls to control another measure of performance. For instance, cell current is measured and the cell voltage is varied (or the anode overvoltage is varied) to hold the current constant. Simultaneously, the cell power is measured and the mass flow is varied to maximize cell power. Alternatively, the anode overvoltage and mass flow could be varied to allow current and power to follow a specific trajectory.

In another embodiment, the following steps are included. The methods described in the previous embodiments are used, but the timing is optimized by an optimization procedure. The objective of the optimization may be to maximize power, efficiency, match a time varying load or another measure of performance or even two measures of performance by use of control variables such as current, overvoltage, cell voltage or external impedance. The objective may also be subjected to certain constraints such as avoiding negative cell voltages or avoiding voltage fluctuations that are known to cause durability problems.

When the controls are applied for cleaning and the cell voltage drops, the method of the invention can be applied, for example by use of an appropriate control algorithm, to ensure that the voltage does not reach a level low enough to cause degradation of the fuel cell catalyst, membrane, supports or other components.

The technique of the invention may be generalized further. Instead of simple voltage levels for triggering, any function of the cell voltage, anodic overvoltage, and derivatives of these voltages may be used. Furthermore, the timing of the variation of the mass flow controls with respect to the current controls may be varied. Ultimately, the mass flow and current controls may be represented as a set of parameters—for instance, the coordinates representing changes of mass flow and time, and current and time—and these parameters may then be optimized in an optimal control sense. As one example, an optimization algorithm could be used to define the optimum mass flow, current or voltage waveforms to meet a specific objective such as maximizing the power delivered to a load. Suitable optimization algorithms could be Nelder-Mead, pattern searches, etc. This approach can be done on a purely experimental basis without a model of the phenomena. Essentially an initial set of parameters governing the waveforms would be specified and the fuel cell would be operated for a specified period of time with these parameters. Then a measure of performance, such as average power at a specified current, would be computed from direct measurements of the fuel cell. The optimization method would then vary the parameters, measure and recompute the measure of performance repeatedly until the optimal parameters are found. The algorithm would then maintain the parameters in the optimal state. This technique was described in WO 03/067696 A2 for voltage or current controls and the present invention extends those techniques to include mass flow as an independent variable.

Closed loop control methods, such as sliding mode control, could also be used to maintain the optimum waveforms. This could be particularly important as the fuel cell changes in performance over time. The optimization process could be used to maintain the optimum as the fuel cell changes in performance over time. Many control algorithms can be used for the controls that may be model-based or non model-based. For instance, feedback linearization is representative of the former and neural networks or fuzzy logic are representative of the latter.

The time varying voltage and current may be converted in a power converter to deliver power in a suitable manner to a load or to charge a battery or capacitor or similar storage component for delivery to a load. In this manner the time varying nature of the fuel cell can be converted to a more advantageous waveform for matching a load.

In addition to the above, the method of the invention may introduce model-based control without using invasive and/or expensive sensors. Essentially, the concept can be used in conjunction with model-based observers, which analytically mimic a sensor, to improve the performance of a PEM fuel cell. Furthermore, the invention may allow a PEM fuel cell to be operated at near pure H₂ levels with multi-variable control algorithms based on the output of the observers.

The invention can employ mass flow controls that enable improved performance. Recent data suggests that power levels can approach >95% with 500 ppm of CO in a hydrogen fuel compared to operating a fuel cell with pure hydrogen, as shown in the figures below. In that case, the flow was momentarily interrupted by closing a solenoid operated valve in the fuel line upstream of the fuel cell, causing the fuel to be depleted within the fuel cell, the anodic overvoltage to increase, and the cell voltage to decrease, until the CO was oxidized to CO₂. The flow was shut briefly, as the traces from the experiment indicate. The data shows the effectiveness of mass flow controls. We propose that this approach can be used at high CO levels, up to about 10%.

However these pulsed flow techniques rely on a simple measure to determine when to interrupt the flow—for instance, the decrease in cell voltage as CO poisons the electrode. If more fundamental parameters could be measured, such as CO or H₂ coverage on the electrode, then the control algorithm could seek to operate directly on these values to maximize a measure of performance. For instance, one might minimize CO coverage while maximizing H₂ current or power, estimated from hydrogen coverage and known equations, or similar measures of performance increase. One method of characterizing fundamental parameters is to use asymptotic “observers” that simulate the fundamental parameter based upon the measured data. Details of this approach are given in WO 03/067696 A2. The present invention can incorporate techniques described in that patent with the addition of mass flow as an independent variable and the addition of equations describing the variation of surface coverages and currents as a function of mass flow and overvoltage. In a preferred implementation, the observers would use a sliding mode observer structure [Utkin, Sliding Mode Control in Electromechanical Systems, 1999] to estimate the coverage of CO, H₂, OH, and any other electrochemically active species and the mass fraction of CO, CO₂, H₂, OH and any other gas species present in the anode chamber, based upon variations of models available in the open technical literature [for instance, Zhang and Datta, J. Electrochem. Soc., v. 151, n. 5, 2004, pp A689-A697] to form the analytical basis of the observer. The availability of these variables would allow for accurate control of the fuel flow to the anode, and would also lead to improved voltage/current controls for maximizing power delivery, load following or some other characteristic of fuel cell performance. Sliding mode observers have the advantage of exhibiting robust performance in the presence of model uncertainties. Alternatives to observers that a person skilled in the art could use would include neural networks, or other forms of adaptive algorithms available in modern control theory.

When an electrode is pulsed either with mass flow, voltage or current controls, some loss of voltage due to the pulse may occur. This loss is reduced when the fraction of time spent pulsing is minimized or the overvoltage is minimized. The next embodiment of the invention involves intelligent control of the voltage waveform. This may be done to minimize the magnitude or duration of the pulse, or to satisfy some other system constraint such as avoiding conditions that decrease reliability, such as cell reversal. This method uses a high overvoltage to achieve a low coverage of CO on the anode and then a much smaller overvoltage to maintain a desired hydrogen coverage or high current or power from the electrode. The overvoltage is varied by independent control of the mass flow and either cell voltage or cell current. In some cases, the overvoltage may be varied directly by controlling the voltage between the anode and a reference electrode while simultaneously varying the mass flow. Over time, the hydrogen coverage may gradually degrade and the method may be repeated as needed.

The method uses a model that is based upon the coverage of the electrode surface with hydrogen and CO. In the following sections, we present several mathematical techniques to (1) clean the surface of CO by raising the overvoltage to minimize the CO coverage and (2) maintain the surface at a desired hydrogen coverage by control techniques. This two part optimization and control problem can be solved by many techniques. WO 03/067696 A2 describes the mathematics behind these techniques. Here, we outline the methods and note that mass flow is an additional independent variable.

One embodiment of the invention relates to a feedback control method of operating a fuel cell comprising applying mass flow, current and/or voltage controls to a fuel cell using the following algorithm:

a) determining a mathematical model that relates the instantaneous coverage of hydrogen and carbon monoxide to the overvoltage applied to the anode;

b) forming an observer that relates the instantaneous coverage of the hydrogen and carbon monoxide to the measured current, voltage and mass flow of fuel and oxygen to the fuel cell;

c) driving the estimated carbon monoxide coverage to a low value by varying the overvoltage through the independent control of fuel flow, cell voltage or cell current, or by directly varying the overvoltage with respect to a reference electrode;

d) driving the estimated hydrogen coverage to a desired value by varying the overvoltage in a similar manner as c); and

e) repeating steps a) through d) as necessary.

Another embodiment of the invention relates to a feedback control method of operating a fuel cell comprising applying mass flow, current and/or voltage controls to a fuel cell using the following algorithm:

a) determining a mathematical model that relates the instantaneous coverage of hydrogen and carbon monoxide to the overvoltage applied to the anode;

b) forming an observer that relates the instantaneous coverage of the hydrogen and carbon monoxide to the measured current of the fuel cell;

c) prescribing a desired trajectory of the instantaneous coverage of the hydrogen and carbon monoxide as a function of time;

d) forming a set of mathematical relationships from steps a), b) and c) that allows the current to be measured, the overvoltage to be prescribed and the instantaneous carbon monoxide coverage and instantaneous hydrogen coverage to be predicted;

e) driving the carbon monoxide coverage along the desired trajectory by varying the overvoltage according to step d);

f) driving the hydrogen coverage along the desired trajectory by varying the overvoltage according to step d); and

g) repeating steps a) through f) as necessary.

Another embodiment of the invention relates to a feedback control method of operating an electrochemical apparatus operated using a fuel containing an electrochemically active contaminant, the method comprising applying voltage control to an anode of the apparatus using the following algorithm:

a) determining a mathematical model that relates the instantaneous coverage of fuel and contaminant to the overvoltage applied to the anode;

b) forming an observer that relates the instantaneous coverage of the fuel and contaminant to the measured current of the apparatus;

c) driving the estimated contaminant coverage to a low value by varying the overvoltage;

d) driving the estimated fuel coverage to a desired value by varying the overvoltage; and

e) repeating steps a) through d) as necessary.

A further embodiment of the invention relates to a feedback control method of operating an electrochemical apparatus operated using a fuel containing an electrochemically active contaminant, the method comprising applying voltage control to an anode of the apparatus using the following algorithm:

a) determining a mathematical model that relates the instantaneous coverage of fuel and contaminant to the overvoltage applied to the anode;

b) forming an observer that relates the instantaneous coverage of the fuel and contaminant to the measured current of the apparatus;

c) prescribing a desired trajectory of the instantaneous coverage of the fuel and contaminant as a function of time;

d) forming a set of mathematical relationships from steps a), b) and c) that allows the current to be measured, the overvoltage to be prescribed and the instantaneous contaminant coverage and instantaneous fuel coverage to be predicted;

e) driving the contaminant coverage along the desired trajectory by varying the overvoltage according to step d);

f) driving the fuel coverage along the desired trajectory by varying the overvoltage according to step d); and

g) repeating steps a) through f) as necessary.

The invention also relates to a feedback control method of operating a fuel cell comprising applying voltage control to an anode of the fuel cell using the following algorithm:

a) determining a mathematical model that relates the instantaneous coverage of hydrogen and carbon monoxide to the measured variables of the electrode or fuel cell;

b) calculating the optimal waveform(s) of the control variable(s) to maximize a performance function, such as the fuel cell power, current or ability to follow a useful load, for a discrete set of instantaneous coverage of the hydrogen and carbon monoxide;

c) forming an observer that relates the instantaneous coverage of the hydrogen and carbon monoxide to the measured variables of the fuel cell;

d) using the estimated coverages from c) to select the corresponding optimal waveform(s) from b) to maximize the performance function for a specified period of time; and

e) repeating steps c) and d) or b) through d) as necessary.

The mathematical model in a) may also need to be adjusted periodically to agree with measured data, requiring steps a) through e) to be repeated. In step b), the optimal waveform may be calculated by any of a number of methods, including methods such as Nelder-Mead optimization, steepest descent, Powell's method, dynamic programming, solution of the Hamilton-Jacobi-Bellman equations, etc.

A modified form of the above approach first finds the optimal control and then adjusts the waveform to maintain that optimum as the electrochemical system changes slowly due to changes over time in the electrodes, membranes, electrolytes, or other components of the electrochemical system. This modified form includes the following steps:

a) determining a mathematical model that relates the instantaneous coverage of hydrogen and carbon monoxide to the measured variables, including the control variables, of the electrode or fuel cell;

b) calculating the optimal waveform(s) of the control variable(s) to maximize a performance function, such as the fuel cell average power, current or ability to follow a useful load, for a discrete set of instantaneous coverage of the hydrogen and carbon monoxide;

c) forming an observer that relates the instantaneous coverage of the hydrogen and carbon monoxide to the measured variables of the fuel cell;

d) using the estimated coverages from c) to select the corresponding optimal waveform(s) from b) to maximize the performance function for a specified period of time;

e) varying the parameters describing the waveform(s) to further maximize the performance function; and

f) repeating steps c) through e) or b) through e) as necessary.

The mathematical model in a) may also need to be adjusted periodically to agree with measured date, requiring steps a) through f) to be repeated. The optimization step in e) can also be done with available existing optimization methods, as described previously, but this step should be simpler, since the waveform should be close to the optimal value. The waveform is being corrected for slow changes in system performance. Consequently, approaches that linearize the modified waveform about the initial waveform may be appropriate, and a wide variety of techniques are applicable to this problem. For instance, approaches related to dynamic programming are described in Chapter 4 of Robinett et al., Applied Dynamic Programming for Optimization of Dynamical Systems, SIAM, 2005.

In one embodiment, the invention relates to a method of operating a fuel cell comprising: a) applying a time-varying amplitude of a flow of fuel or oxidant to an anode or cathode of the fuel cell, the fuel or oxidant containing a contaminant; b) applying at least one time-varying electrical parameter to the entire fuel cell, individual cells or groups of cells, where the parameter includes at least one of current, voltage, electrode overvoltage, and impedance; and c) using a controller to control the timing and the time-varying amplitude of the flow and the at least one electrical parameter to maximize a performance measure of the fuel cell. Any suitable controller can be used, and various types are well known.

In another embodiment, the invention relates to a method of operating an electrochemical device comprising: a) applying a time-varying and amplitude-varying flow of reactants to an anode or a cathode of the device, the reactants including a reactant that causes an undesired electrochemical reaction or adsorption onto the anode or cathode; b) applying at least one time-varying electrical parameter to the entire device, individual cells or groups of cells, where the parameter includes at least one of current, voltage, electrode overvoltage, and impedance; and c) using a controller to control the timing and the time-varying amplitude of the flow and the at least one electrical parameter to maximize a performance measure of the electrochemical device. The reactants can include any that are used in an electrochemical reaction. Also, the method can include any type of reactant causing an undesired electrochemical reaction and/or undesired adsorption onto the anode or cathode. A nonlimiting example of such a reactant is hydrogen sulfide.

### EXAMPLES

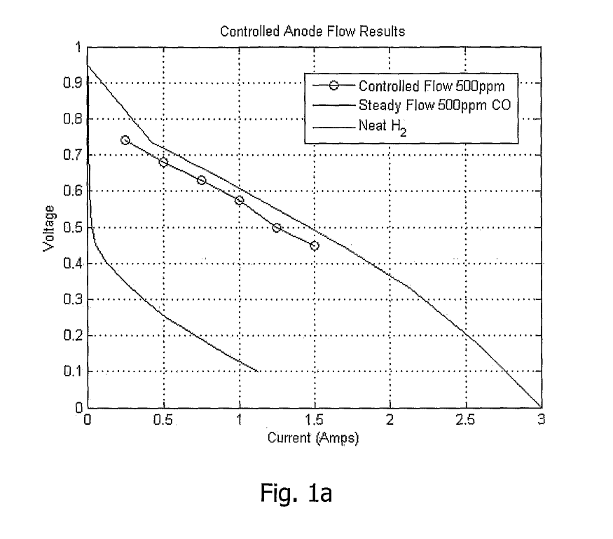

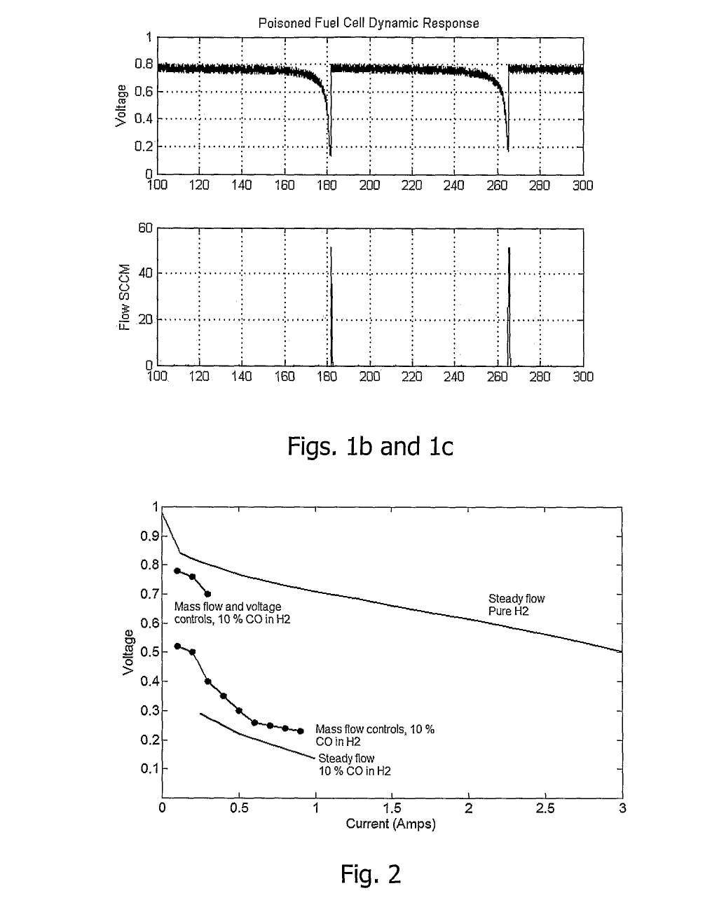

In these examples we show that our invention of combining the mass flow controls with current or voltage controls enables a fuel cell to operate with high levels of CO in the fuel stream. The experiments were carried out with a 5 cm² cell using a Pt—Ru anode and a Pt cathode. FIG. 1a shows a plot of average cell voltage versus average cell current for pure hydrogen and 500 ppm of CO in hydrogen at room temperature. Three curves are shown: (a) pure hydrogen operating in a conventional, steady manner (b) hydrogen with 500 ppm CO operated in a conventional, steady manner, and (c) hydrogen with 500 ppm CO operated using mass flow controls alone. The average voltage and current is plotted in (c), but the time varying voltage and mass flow are shown in FIGS. 1a and 1b. It is clear from the figure that at 500 ppm CO, the mass flow controls (c) are sufficient to keep the cell voltage close to the pure hydrogen performance (a). However, we next perform an experiment at 70 C and the results are shown in FIG. 2 with (a) pure hydrogen, (b) hydrogen with 10% CO operated in a conventional, steady manner, (c) hydrogen with 10% CO operated with mass flow controls alone, (d) hydrogen with 10% CO operated with mass flow and current controls combined. When mass flow controls are used alone (c) the cell voltage is much lower than operation with pure H2. When mass flow and current controls are combined in (f) the cell voltage is close to the pure hydrogen case (a).

The combined mass flow and current controls in the preceding paragraph used an imposed train of current pulses with mass flow triggered on when the cell voltage declined below a specified value. The mass flow was triggered off when the cell voltage climbed above a given value.

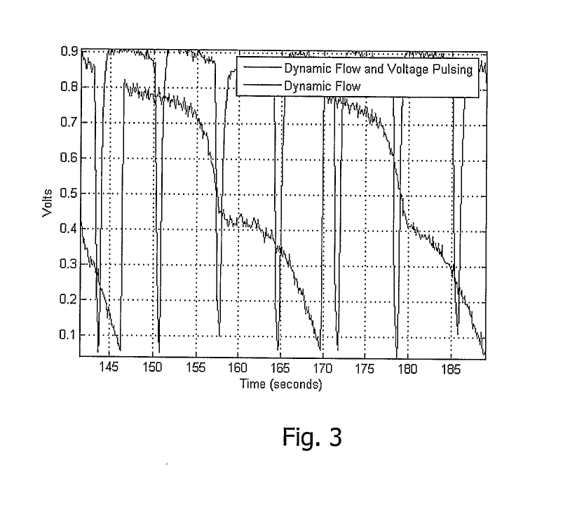

FIG. 3 shows voltage traces as a function of time when our cell was operated in two different modes: (1) with combined mass flow and current controls, and (2) with mass flow controls alone. As the figures show, the voltage loss is much less with the combined mass flow and current controls, indicating that the power is substantially higher with the combined technique.

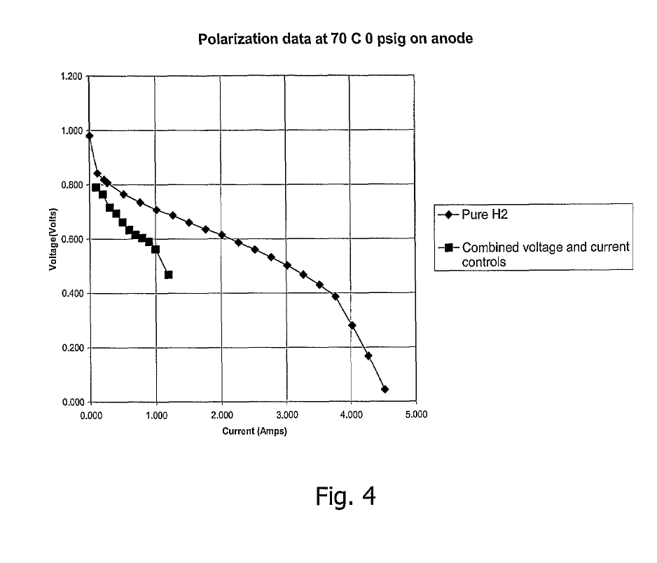

We repeated this testing with 1% CO in hydrogen while operating the cell at 70 C, and these results are shown in FIG. 4. In (a) pure hydrogen is used as the fuel with conventional, steady operation. In (b) both mass flow and current controls are combined. The mass flow was triggered on when the cell voltage dropped to 0.1 volts and was turned off when the voltage rose back to 0.1 volts. The current was raised to 1 Amp for 0.4 seconds just before the mass flow was triggered on. The cell voltage was approximately 0 volts at the minimum. The improvement is substantial. For instance at 1 amps the power, which is cell voltage times cell current, is approximately 80% of the pure hydrogen power. In contrast, a fuel cell with a similar PtRu anode catalyst achieved 60% of the pure hydrogen power when operated with 50 ppm of CO in hydrogen with steady flow in the conventional manner [Lee et al., Electrochimica Acta 44 (1999) 3283-3293, FIG. 6].

This invention should also be applicable to other fuel cell types, such as direct methanol fuel cells and other direct fuel oxidation cells, where the fuel flow rate is modulated and the current or voltage is modulated and an intermediate species such as CO poisons the reaction.

Because of this outstanding performance with mass flow controls, it may be possible to use the mass flow and voltage or current controls concepts to reduce the catalyst loading required for CO tolerance. Furthermore, ruthenium, which is widely used to improve CO tolerance, has been shown to be a durability problem in fuel cells due to the tendency of ruthenium to dissolve and migrate away from the active layer. Performance from this concept may be sufficient to allow the catalyst to provide sufficient CO tolerance with reduced ruthenium or no ruthenium at all. It may also be possible to reduce the platinum loading with this approach. High platinum loadings for CO tolerance are a major component of fuel cell costs in some applications, particularly transportation.

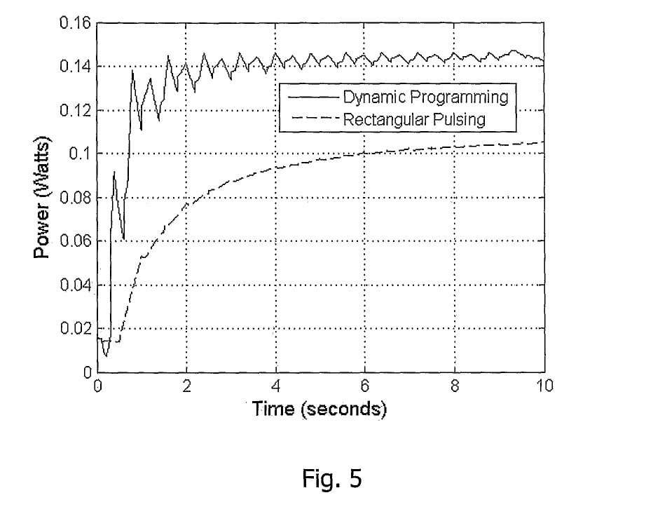

To illustrate the use of observers and model-based control, a 5 cm² fuel cell was operated at 50 C and atmospheric pressure. The cell was operated as a half cell, with hydrogen and/or CO flowing on the anode and hydrogen flowing on the cathode as a reference. The model of Springer et al [T. E. Springer, T. Rockward, T. A. Zawodzinski, S. Gottesfeld, Journal of the Electrochemical Society, 148, A11-A23 (2001)] was fit to pulsed data using two fuels: (1) pure hydrogen and (2) hydrogen and 1% CO. The average power loss over a fixed period of operation was computed by averaging the product of overvoltage and current using the mathematical model. A dynamic programming algorithm was used to determine an improved overvoltage waveform compared to pulsing with rectangular waveforms [Kirk, Donald E., Optimal Control Theory, Englewood Cliffs, N.J., Prentice Hall Inc., 1970]. The dynamic programming solution gives the desired trajectory of overvoltage versus time for a discrete set of times, with values at intermediate times found by interpolation, and also as a function of initial and present hydrogen and CO coverage fractions. The observers are then fit to experimental data to determine the current hydrogen and CO coverage. The observers are defined as the state equations used to model the coverage dynamics with the predicted deviation from current measurement used as the control input to the observer state equations. For instance in (84,85), assuming all current contribution came from H₂, they would take on that form. Then if the contribution of CO current was included it would take the form of [59-61]

$$\begin{matrix}\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {e}^{\frac{η}{{b}_{c}}} + {l}_{1} sign ( \overline{i} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + {l}_{2} sign ( \overline{i} )\end{matrix} \\ \overline{i} = i - {C}_{dl} \frac{d η}{d t} - 2 {k}_{eH} {θ}_{H} sinh ( \frac{η}{{b}_{H}} ) - {k}_{ec} {\hat{θ}}_{CO} {e}^{\frac{η}{{b}_{c}}}\end{matrix}$$

Where i is the measured current, η is the overvoltage, \hat{θ}_{CO}, \hat{θ}_{H} are the CO and H2 coverage observers, respectively, P_{H}, P_{CO} are the partial pressures, C_{dl} is the anode capacitance, and the k, b symbols are fitted constants, defined and discussed further in [T. E. Springer, T. Rockward, T. A. Zawodzinski, S. Gottesfeld, Journal of the Electrochemical Society, 148, A11-A23 (2001)]. Knowing the coverages, the overvoltage trajectory to minimize power loss from the current time forward is then known from the dynamic programming solution. FIG. 5 shows a plot of equivalent full cell power as a function of time for two cases: the optimized dynamic programming solution, and rectangular pulsing. The equivalent full cell power is approximated as the running average of (1.2−overvoltage)*current.

### International Publication No. WO 03/067696 A2

The invention relates in general to methods of removing electrochemically active contaminants from electrochemical processes. The methods may apply to any electrochemical process in which a contaminant is being oxidized so that another reaction can proceed. The electrochemically active contaminant is any contaminant that can be removed by setting the operating voltage at a voltage bounded by −Voc and +Voc, where Voc is the open circuit voltage of the apparatus used in the process. In some particular embodiments, the invention relates to methods of removing carbon monoxide or other contaminants from the anode or cathode of a fuel cell, thereby maximizing or otherwise optimizing a performance measure such as the power output or current of the fuel cell.

The methods usually involve varying the overvoltage of an electrode, which is the excess electrode voltage required over the ideal electrode voltage. This can be done by varying the load on the device, i.e., by placing a second load that varies in time in parallel with the primary load, or by using a feedback system that connects to the anode, the cathode and a reference electrode. A feedback system that is commonly used is the potentiostat. In some cases the reference electrode can be the cathode; in other cases it is a third electrode.

Broadly, the different methods involve the following concepts:

Obtaining useful power during the cleaning pulse of a pulsed cleaning operation used to remove contaminants from an electrochemical apparatus, for example, to remove CO from a fuel cell electrode. This enables (1) operation of a fuel cell at high CO levels, (2) a simplified fuel cell system with a reformer that produces CO at up to 10% instead of the usual 50 ppm or so, and (3) a fuel cell operating at nearly constant voltage with high current output, using a voltage booster that operates during the cleaning pulse.

Control of the voltage waveform during a cleaning operation to minimize the magnitude or duration of the cleaning voltage, maximize performance, and/or to satisfy some other system constraint, such as following the load or avoiding voltage and current conditions that adversely affect reliability of the electrode or apparatus.

A feedback control technique based on a natural oscillation in electrochemical system voltage to maintain a desired current, load profile, or to maximize performance by cleaning contaminants.

Improved Waveform for Pulsing a Fuel Cell Anode or Cathode to Maximize the Current or Power Produced, and General Method for Optimizing the Pulsing Waveform Applied to any Electrode

In two preferred embodiments, the invention provides:

An improved waveform for pulsing a direct methanol fuel cell, where the anode potential is made negative with respect to the cathode, followed by the usual power production potential which was about 0.6 volts relative to SCE in our half cell experiments.
A general method for optimizing the cleaning waveform that can be applicable to any type of electrode, and may have applications well beyond fuel cells in areas such as battery charging, electrode sensors, analytical chemistry, and material manufacturing.

Experiments were performed with a standard three electrode cell containing 1.0 M methanol and 0.5 M sulfuric acid. The anode was platinum and the cathode was a saturated calumel electrode (“SCE”). This was a batch system with the fuel (methanol) mixed with the electrolyte (sulfuric acid) in the cell. The anode voltage was controlled by a potentiostat with a voltage waveform that could be generated either by the potentiostat directly or by externally triggering the potentiostat with a programmable function generator. The resulting data, shown in FIG. 1 for five different experiments, show that the current output is larger and substantial when the waveform is made negative (relative to the cathode) during a short cleaning pulse. FIG. 2 illustrates this better, showing that the charge delivered is larger when the cleaning pulse is negative and the voltage level during power production is at 0.6 volts (the top curve—dashed), which is near the peak methanol oxidation potential from a cyclic voltammogram. For comparison the solid black curve has a cleaning potential at 0.0 volts and power production at 0.6 volts. Notice that the current traces have a positive and a negative component to them. When the current is positive, the cell is delivering current. When the current is negative, the cell is receiving current. Consequently, it is desirable to maximize the positive current and minimize the negative current.

To influence the positive and negative currents, we varied the shape of the voltage pulses. The results show that varying the voltage shapes can strongly influence the shape of the current traces and can reduce the negative current.

The results of these experiments indicate that the waveform can be optimized by a systematic, computational procedure in order to deliver substantially more power than existing fuel cells. The experiments show that varying the waveform can significantly vary the current output.

To illustrate the method, consider a waveform to be represented by a fixed number of points. The number of points is arbitrary, but the more points, the longer the optimization time that is required. The waveform is a voltage or current waveform that is connected to the anode of a fuel cell, such that the anode is operated at that voltage, or perhaps is operated at that voltage plus or minus a fixed offset voltage. The offset voltage may vary slowly with the operating conditions due to, for instance, changes in the load. The waveform variation is much faster than any variation in the offset voltage.

This waveform pattern is fed to the anode and repeated at a frequency specified by the points, as the figure illustrates. Measurements are made of the power or current or other performance parameter, whichever is most appropriate, delivered by the fuel cell. The performance parameter and waveform points are then fed to an algorithm, which may be in a computer program or hand calculation, which optimizes the waveform shape to maximize the performance, such as power or current delivered.

The optimum waveform can thus be determined for the specific fuel cell electrode and operating conditions. This optimizing procedure can be repeated as often as necessary during operation to guard against changes in the electrode or other components over time or for different operating conditions.

Mathematically, the points describing the waveform can be considered to be independent variables for the optimization routine. The net current or power produced (current or power that is output minus any current or power supplied to the electrode) is the objective function to be optimized. A person skilled in the art of optimization could select a computer algorithm to perform the optimization. Typical algorithms might include steepest descent, derivative-free algorithms, annealing algorithms, or many others well-known to those skilled in the art.

Alternatively, the waveform could be represented by a set of functions containing one or more unknown coefficients. These coefficients are then analogous to the points in the preceding description, and may be treated as independent variables in the optimization routine. As an example, the waveform could be represented by a Fourier Series, with the coefficient of each term in the series being an unknown coefficient.

Obtaining Useful Power During the Cleaning Pulse of a Pulsed Cleaning Operation Used to Remove Contaminants from an Electrochemical Apparatus

Pulsed cleaning of electrochemically active contaminants from an electrode of an electrochemical apparatus involves raising the overvoltage of the electrode to a sufficiently high value to oxidize the contaminants adsorbed onto the electrode surface. For example the pulsed cleaning of an anode or cathode of a fuel cell usually involves raising the overvoltage to oxidize adsorbed CO to CO₂. When a sufficient amount of time has elapsed, the overvoltage is dropped back to the conventional overvoltage where power is produced. Conventional thinking is that little or no useful power is generated during the cleaning pulse. However, our work with pulsing of a fuel cell anode has surprisingly shown that high current can be obtained during the cleaning pulse. Also surprisingly, our work has shown that when the hydrogen fuel contains high levels of CO, up to 10%, currents can be obtained approaching that obtained when pure hydrogen is used as the fuel. We have discovered that pulsing of a fuel cell anode allows the fuel cell to operate using a hydrogen fuel containing greater than 1% CO, up to 10% CO or possibly higher. Pulsing can take care of much larger amounts of CO than previously thought. In the past, most fuel cells have been operated using a hydrogen fuel containing 50 to 100 PPM, whereas we have found that up to 10% or more CO can be used (at least 10,000 times the previous level). This invention permits a step change increase in CO contamination with minimal impact on current output.

Advantageously, the ability to operate a fuel cell with hydrogen having high CO levels enables a simplified, less costly fuel cell system to be used. Operation at high CO levels enables the fuel processor to be much simpler, less costly and smaller in size. The fuel processor of a conventional fuel cell system usually includes a fuel reformer, a multi-stage water-gas shift reactor and a CO cleanup reactor. The simplified fuel processor of the invention can include a fuel reformer and a simplified water-gas shift reactor, for example a one-stage or two-stage reactor instead of a multi-stage reactor. In some cases, the water-gas shift reactor can be eliminated. The cleanup reactor can usually be eliminated in the simplified fuel processor. Essentially this invention enables the fuel cell electrode to tolerate CO concentrations of 10% or higher, and therefore the fuel processor can operate with simplified components since it can produce CO concentrations of 10% or higher.

We have examined the fuel cell voltage and current for 1% CO in hydrogen. In a first case, the overvoltage waveform varied between 0.5 and 0.7 volts. In a second case, the overvoltage varies between 0.05 and 0.65 volts. The cell current is high when the voltage reached 0.7 volts, but is much lower when the voltage reached 0.65 volts. This indicates that 0.7 volts is the co-oxidizing voltage. The initial peak in current, when the voltage first reached 0.7 volts, is expected to be the CO being oxidized. The current then decreases and then increases steadily as the hydrogen reaches the newly cleaned surface. The hydrogen current is high at this large overvoltage.

Consequently, the current is high during the CO oxidizing voltage, but the overall cell output voltage is low (since the overvoltage is high). However, the power, which is defined as the product of voltage times current, is surprisingly high for CO concentrations greater than 1%. This enables various voltage conditioning circuits to be used to convert the current or voltage or both to a desired form. In one embodiment of the invention, the output voltage is boosted to a more usable value by using a voltage boosting circuit, such as a switching circuit. These devices typically keep the output energy nearly the same (efficiencies are usually over 80%), but increase the voltage while decreasing the current. Thus, one embodiment of the invention relates to a fuel cell having a pulsed electrode in combination with a voltage conditioning circuit, such as a voltage booster to change the cell voltage during the oxidation pulse to a desired level. Furthermore, all of the cleaning techniques described herein may be used for fuel cells with CO concentrations greater than 1%.

Model Based Feedback Control of the Electrode Voltage

When an electrode is pulsed, some loss of voltage due to the pulse is inevitable. This loss is reduced when the fraction of time spent pulsing is minimized or the overvoltage is minimized. The next modification involves intelligent control of the voltage waveform. This may be done to minimize the magnitude or duration of the pulse, or to satisfy some other system constraint such as avoiding conditions that decrease reliability. Here, we present a method of using a high overvoltage to achieve a low coverage of CO on the anode and then a much smaller overvoltage to maintain a high hydrogen coverage and thus high current from the electrode. Over time, the hydrogen coverage may gradually degrade and the method may be repeated as needed.

The method uses a model based upon the coverage of the electrode surface with hydrogen (θ_{H}) and CO (θ_{co}). In the following sections, we present several mathematical techniques to (1) clean the surface of CO by raising the overvoltage to minimize the CO coverage and (2) maintain the surface at high hydrogen coverage by maximizing the hydrogen coverage. This two part optimization and control problem can be solved by many techniques. Below we illustrate the techniques of feedback linearization, sliding mode control, and optimal control by a series of examples.

### Example 1

### Feedback Linearization

The steps are as follows.

Develop a model for the fuel cell in question that relates the time derivative of θ_{H} and θ_{co} to the overvoltage. The model involves some unknown coefficients that must be found experimentally. For instance, scientists at Los Alamos National Laboratory have proposed the following model (T. E. Springer, T. Rockward, T. A. Zawodzinski, S. Gottesfeld, Journal of the Electrochemical Society, 148, A11-A23 (2001), which is incorporated by reference). The unknown coefficients are the k's and the b's, and η is the overvoltage

$$\begin{matrix}{\dot{θ}}_{CO} = {k}_{fc} {P}_{CO} ( 1 - {θ}_{CO} - {θ}_{H} ) - {b}_{fc} {k}_{fc} {θ}_{CO} - {k}_{ec} {θ}_{CO} {e}^{\frac{η}{{b}_{c}}} \\ {\dot{θ}}_{H} = {k}_{fH} {{P}_{H} ( 1 - {θ}_{CO} - {θ}_{H} )}^{2} - {b}_{fH} {k}_{fH} {θ}_{H}^{2} - 2 {k}_{eH} {θ}_{H} sinh ( \frac{η}{{b}_{H}} )\end{matrix}$$

Develop a model, called a set of observers that relates θ_{H} and θ_{co} to the measured current of the cell, j_{H}. The observer equations are numerically integrated in real time and will converge to the coverage values, θ_{H} and θ_{co}. The parameters l₁ and l₂ determine the rate of convergence.

$$\begin{matrix}\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {e}^{\frac{η}{{b}_{c}}} + {1}_{1} ( {θ}_{H} - {\hat{θ}}_{H} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + {1}_{2} ( {θ}_{H} - {\hat{θ}}_{H} )\end{matrix} \\ {θ}_{H} = \frac{{j}_{H}}{2 {k}_{eH} sinh ( \frac{η}{{b}_{H}} )}\end{matrix}$$

Develop a desired trajectory for the variation of θ_{co} and θ_{H} in time. This trajectory may be chosen to maximize durability of the cell, minimize the expected overvoltage changes, or for some other reason. That is, constraints may be prescribed on any of the variables. In this example, we use a first order trajectory to reach the desired state values θ_{H}^{d} and θ_{CO}^{d}.

\dot{θ}_{H}=−α(θ_{H}−θ_{H}^{d})

\dot{θ}_{CO}=−β(θ_{CO}−θ_{CO}^{d})

Equate the time derivative of θ_{co} in the trajectory (3) to the time derivative of θ_{co} in the observer model (2). Equate the time derivative of θ_{H} in the trajectory (4) to the time derivative of θ_{H} in the observer model (2).

$$\begin{matrix}- β {\hat{θ}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {e}^{\frac{η}{{b}_{c}}} \\ - α {\hat{θ}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} )\end{matrix}$$

Solve for the overvoltage from the θ_{co} equation in (5).

$$η - ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{c}$$

Solve for the overvoltage from the θ_{H} equation in (5).

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$

Vary the overvoltage according to 6 to drive θ_{co} to a desired value.
When θ_{co} reaches the desired value, vary the overvoltage according to 7 to drive θ_{H} to a desired value.
Repeat when needed.

In a plot showing the overpotential as a function of time, the overpotential is high for about 13 seconds and low for the remaining time. The coverage of CO is reduced from about 0.88 to 0.05 by applying step 5, followed by the coverage of hydrogen being increased from near zero to 0.95 by applying step 6. The hydrogen coverage will gradually degrade over time and the process will be repeated periodically.

### Example 2

### Sliding Mode Control

The exact feedback linearization technique presented above may not always be achievable due to the uncertainty of the model parameters (k's and b's). Therefore sliding mode control techniques can be applied to reduce sensitivity to the model parameters. The design procedure is as follows:

Develop a model, called a set of observers, that relates θ_{H} and θ_{co} to the measured current of the cell, j_{H}. The observer equations are numerically integrated in real time and will converge to the coverage values, θ_{H} and θ_{co}. The parameters l₁ and l₂ determine the rate of convergence.

$$\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {e}^{\frac{η}{{b}_{c}}} + {1}_{1} ( {θ}_{H} - {\hat{θ}}_{H} ) \\ {{θ}^{\dot{\hat{}}}}_{H} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + {1}_{2} ( {θ}_{H} - {\hat{θ}}_{H} ) \\ {θ}_{H} = \frac{{j}_{H}}{2 {k}_{eH} sinh ( \frac{η}{{b}_{H}} )}\end{matrix}$$

2. Develop a desired trajectory for the variation of θ_{co} and θ_{H} in time. This trajectory may be chosen to maximize durability of the cell, minimize the expected overvoltage changes, or for some other reason. That is constraints may be prescribed on any of the variables. In this example, we use a first order trajectory to reach the desired state values θ_{H}^{d} and θ_{CO}^{d}.

\dot{θ}_{H}=−α(θ_{H}−θ_{H}^{d})

\dot{θ}_{CO}=−β(θ_{CO}−θ_{CO}^{d})
3. Design the CO sliding surface as the CO coverage minus the integral of the desired state trajectory:

S_{CO}=\hat{θ}_{CO}−∫β(\hat{θ}_{CO}−θ_{CO}^{d})
4. Design control as η=M*sign(S_{CO}), where M is some constant used to enforce sliding mode.
5. After sliding mode exists the equivalent control is defined as:

$$η = ln ( \frac{- β ( {\hat{θ}}_{CO} - {\hat{θ}}_{CO}^{d} ) - {k}_{fc} {P}_{CO} ( 1 - {\hat{θ}}_{CO} - {\hat{θ}}_{H} ) + {b}_{fc} {k}_{fc} {\hat{θ}}_{CO}}{- {k}_{ec} {\hat{θ}}_{CO}} ) {b}_{c}$$

6. Design the H₂ sliding surface as the H₂ coverage minus the integral of the desired state trajectory

S_{H}=\hat{θ}_{H}−∫α(\hat{θ}_{H}−θ_{H}^{d})
7. Design control as η=M*sign(S_{H}), where M is some constant used to enforce sliding mode.
8. After sliding mode exists the equivalent control is defined as:

$$η = {sinh}^{- 1} ( \frac{- α ( {\hat{θ}}_{H} - {\hat{θ}}_{H}^{d} ) - {k}_{fH} {{P}_{H} ( 1 - {\hat{θ}}_{CO} - {\hat{θ}}_{H} )}^{2} + {b}_{fH} {k}_{fH} {\hat{θ}}_{H}^{2}}{- 2 {k}_{eH} {\hat{θ}}_{H}} ) {b}_{H}$$

9. Vary the overvoltage according to 4 to drive θ_{co} to a desired value.
10. When θ_{co} reaches the desired value, vary the overvoltage according to 7 to drive θ_{H} to a desired value.
11. Repeat when needed.

### Example 3

### Optimal Control

Optimal control can also be implemented to minimize the power applied to the cell used to stabilize the hydrogen electrode coverage, hence maximizing the output power of the cell. The steps are as follows:
1. Develop a model, called a set of observers, that relates θ_{H} and θ_{co} to the measured current of the cell, j_{H}. The observer equations are numerically integrated in real time and will converge to the coverage values, θ_{H} and θ_{co}. The parameters l₁ and l₂ determine the rate of convergence.

$$\begin{matrix}{{θ}^{\dot{\hat{}}}}_{CO} = {k}_{fc} {P}_{CO} ( 1 - {\hat{θ}}_{CO} - {\hat{θ}}_{H} ) - {b}_{fc} {k}_{fc} {\hat{θ}}_{CO} - {k}_{ec} {\hat{θ}}_{CO} {e}^{\frac{η}{{b}_{c}}} + {1}_{1} ( {θ}_{H} - {\hat{θ}}_{H} ) \\ {θ}^{\dot{\hat{}}} = {k}_{fH} {{P}_{H} ( 1 - {\hat{θ}}_{CO} - {\hat{θ}}_{H} )}^{2} - {b}_{fH} {k}_{fH} {\hat{θ}}_{H}^{2} - 2 {k}_{eH} {\hat{θ}}_{H} sinh ( \frac{η}{{b}_{H}} ) + {1}_{2} ( {θ}_{H} - {\hat{θ}}_{H} ) \\ {θ}_{H} = \frac{{j}_{H}}{2 {k}_{eH} sinh ( \frac{η}{{b}_{H}} )}\end{matrix}$$

2. Develop a cost function used to minimize the power applied to the cell as the CO coverage is driven to the desired value θ_{CO}^{d}. Where A and B are the weights and T₁ is the time interval for the CO control to be applied.

$${\int }_{0}^{{T}_{1}} ( {A ( {\hat{θ}}_{CO} - {θ}_{CO}^{d} )}^{2} + B {η}^{2} ) d t$$

3. Solve for the overvoltage to drive CO to the desired value by applying dynamic programming techniques as described in Kirk, Donald E., Optimal Control Theory, Englewood Cliffs, N.J., Prentice Hall Inc., 1970. Apply the overvoltage for time zero at the lower limit of integration.
4. Develop a cost function used to maximize the power output of the cell as the H₂ coverage is driven to the desired value θ_{H}^{d}. Where A and B are the weights and T₂−T₁ is the time interval for the hydrogen control to be applied.

$${\int }_{{T}_{1}}^{{T}_{2}} ( {A ( {\hat{θ}}_{H} - {θ}_{H}^{d} )}^{2} - {B ( {E}_{0} - η )}^{2} {I}^{2} ) d t$$

5. Solve for the overvoltage as in step 3. Apply the overvoltage for time T₁ to T₂.
6. Repeat as necessary.

A Feedback Control Technique Based upon Natural Oscillations in Fuel Cell Voltage to Clean the Electrode

It has been known for some time that some electrodes, when operated as an anode with hydrogen and carbon monoxide, can result in an oscillating current or voltage. In fact this has been known for other competing reactions on electrodes as well. One explanation of this effect is as follows for a system operated at constant current. On an initially clean electrode, the hydrogen reacts and the carbon monoxide begins to poison the surface, resulting in an increasing overvoltage. At a certain overvoltage, the CO is oxidized to CO₂ and the poison is removed, decreasing the overvoltage back to nearly the original, clean surface value. Deibert and Williams (“Voltage oscillations of the H2/CO system”, J. Electrochemistry Soc., 1969) showed that these voltage oscillations were quite strong at levels of CO of 10,000 ppm or 1%. However, the oscillations disappeared when the system was operated at 5% CO.

Since 1% is the approximate concentration of CO from a reforming reaction in a fuel cell, taking advantage of these natural oscillations to periodically clean the electrode is a powerful advantage, eliminating the need for reducing the CO to the 10-50 ppm now required by fuel cell manufacturers. Furthermore, operation of a fuel cell at CO levels higher than 1% and observing the natural oscillations is previously unknown and enables the advantages previously mentioned for high CO level operation.

By using a feedback control system to operate the fuel cell at constant current with levels of CO higher than 1% in the fuel, and letting the control system vary the anode voltage to maintain the constant current output, enhanced performance can result.

Data were obtained in our laboratory using the same 5 cm² fuel cell described in the earlier paragraphs. These data were obtained at constant current operation a PAR Model 273 Potentiostat operated in the galvanostatic mode. Hydrogen fuel was used with four different levels of CO: 500 ppm CO, 1%, 5% and 10%. When the current is increased to 0.4 amps and the concentration of CO is 1% or greater, the cell voltage begins to oscillate with an amplitude that is consistent with the amplitudes expected for CO oxidation. Furthermore, the amplitude increases as the CO level in the fuel increases.

In this application, we first describe a method of maintaining a constant current by varying the voltage. Next we describe using this system to follow a varying current of power. To accomplish this, a feed back control system is used to measure the current of the fuel cell, compare it to a desired value and adjust the waveform of the anode voltage to achieve that desired value.

The controller to be used is any control algorithm or black box method that does not necessarily require a mathematical model or representation of the dynamic system as described in Passino, Kevin M., Stephen Yurkovich, Fuzzy Control, Addison Wesley Longman, Inc., 1998. The control algorithm may be used in accordance with a voltage following or other buffer circuit that can supply enough power to cell to maintain the desired overpotential at the anode. Because the voltage follower provides the power, the controller may be based upon low power electronics. However, in some cases it may be more advantageous to not incorporate the voltage follower in the control circuit, since in some cases external power will not be required to maintain the overvoltage.

The resulting output of the controller will be similar to that described above; with the addition of a voltage boosting circuit the cell may be run at some desired constant voltage or follow a prescribed load.

In some cases, the natural oscillations of voltage may be maintained by providing pulses of the proper frequency and duration to the anode or cathode of the device to excite and maintain the oscillations. Since this is a nonlinear system, the frequency may be the same as or different from the frequency of the natural oscillations. The pulsing energy may come from an external power source or from feeding back some of the power produced by the fuel cell. The fed back power can serve as the input to a controller that produces the pulses that are delivered to the electrode.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A method of operating an electrochemical device comprising controlling a mass flow of fuel to the device so that the mass flow varies during the operation of the device, in combination with controlling an electrical parameter of the device so that the electrical parameter varies during the operation of the device.

2. The method of claim 1 wherein the electrical parameter comprises voltage, current, cell impedance, or any combination of voltage, current, and cell impedance.

3. The method of claim 1 wherein controlling the electrical parameter comprises applying an overvoltage to an electrode of the device during part of the operation of the device.

4. The method of claim 1 wherein controlling the mass flow of fuel comprises reducing the mass flow during part of the operation of the device.

5. The method of claim 4 wherein the mass flow is stopped during part of the operation of the device.

6. The method of claim 1 wherein at least one of the electrical parameter and the mass flow is controlled to pulse during the operation of the device.

7. The method of claim 1 wherein the operation of the device includes the flow of the fuel to the device and the flow of an oxygen source to the device, and wherein the device is operated with at least one of the fuel and the oxygen source containing a level of an electrocontaminant that is at least about 100% higher than the same device operated without the mass flow and the electrical parameter controls.

8. The method of claim 1 wherein the device includes a catalyst loaded on an electrode, and wherein the device is operated with a loading of the catalyst that is at least about 25% lower than the same device operated without the mass flow and the electrical parameter controls.

9. The method of claim 1 wherein the device operated with the mass flow and the electrical parameter controls, compared with the same device operated without the mass flow and the electrical parameter controls, achieves an improvement in operating performance which includes at least one of improved waveform of voltage from the device, improved power delivery from the device, and improved operating efficiency of the device.

10. The method of claim 1 wherein the electrochemical device is a fuel cell.

11. The method of claim 1 which comprises the steps of: (a) applying an overvoltage to an anode of the device, (b) while the overvoltage is applied, reducing the mass flow of fuel to the device, and (c) after a time sufficient to clean a major amount of electrocontaminant from the device, returning the overvoltage and the mass flow to their normal levels for power production.

12. The method of claim 1 which comprises the following steps in order:
(a) flowing the fuel to the device during an initial time period, (b) after the initial time period, stopping the flow of the fuel to the device, (c) when the rate of decay of the voltage of the device drops below a predetermined value, increasing the current of the device from a lower level to a predetermined higher level, (d) before or after step (c), when the voltage of the device falls to a specified level, restarting the flow of fuel to the device, (e) after a time sufficient to clean a major amount of electrocontaminant from the device, and thereby to increase the voltage of the device above a predetermined level, decreasing the current of the device to the lower level, (f) when the voltage rises to a predetermined level, stopping the flow of the fuel to the device.

13. The method of claim 12 wherein the predetermined values are functions of the voltage and the rate of change of voltage with time.

14. The method of claim 1 which comprises a combination of stopping the flow of fuel to the device, applying an overvoltage to an anode of the device, and applying an increased current to an anode of the device.

15. The method of claim 1 including a feedback control system that includes varying the voltage of the device to hold a first measure of device performance constant and varying the mass flow of fuel to the device to hold a second measure of device performance constant.

16. The method of claim 1 which further includes a timing optimization procedure to optimize the timing of varying the mass flow of fuel and the timing of varying the electrical parameter.

17. The method of claim 1 which is applied in a manner to prevent the voltage of the device from decreasing to a level low enough to cause degradation of the device.

18. The method of claim 1 which further comprises an optimization procedure which includes the mass flow control and the electrical parameter control as variables in the process to optimize performance of the device.

19. The method of claim 1 which further comprises a closed loop control method to optimize performance of the device.

20. The method of claim 1 which further comprises converting the time varying voltage and current of the device in a power converter.

21. The method of claim 1 which further comprises the use of a model-based control to control the device.

22. The method of claim 1 which further comprises the use of an observer based upon measured parameters of the device.

23. The method of claim 1 which comprises applying a high overvoltage to clean a major amount of electrocontaminant from an anode of the device and then applying a small overvoltage to maintain a high fuel coverage on the anode and thus high current from the anode, wherein the overvoltage is varied by independent control of the mass flow and either voltage, current, or cell impedance.

24. The method of claim 1 wherein the device is a fuel cell, and the method includes a feedback control method of operating the fuel cell comprising applying mass flow, current and/or voltage controls to the fuel cell using the following algorithm:
a) determining a mathematical model that relates the instantaneous coverage of hydrogen and carbon monoxide to the overvoltage applied to the anode;
b) forming an observer that relates the instantaneous coverage of the hydrogen and carbon monoxide to the measured current, voltage and mass flow of fuel and oxygen to the fuel cell;
c) driving the estimated carbon monoxide coverage to a low value by varying the overvoltage through the independent control of fuel flow, cell voltage or cell current, or by directly varying the overvoltage with respect to a reference electrode; and
d) driving the estimated hydrogen coverage to a desired value by varying the overvoltage in a similar manner as c).

25. The method of claim 1 wherein the device is a fuel cell, and the method includes a feedback control method of operating the fuel cell comprising applying mass flow, current and/or voltage controls to the fuel cell using the following algorithm:
a) determining a mathematical model that relates the instantaneous coverage of hydrogen and carbon monoxide to the overvoltage applied to the anode;
b) forming an observer that relates the instantaneous coverage of the hydrogen and carbon monoxide to the measured current of the fuel cell;
c) prescribing a desired trajectory of the instantaneous coverage of the hydrogen and carbon monoxide as a function of time;
d) forming a set of mathematical relationships from steps a), b) and c) that allows the current to be measured, the overvoltage to be prescribed and the instantaneous carbon monoxide coverage and instantaneous hydrogen coverage to be predicted;
e) driving the carbon monoxide coverage along the desired trajectory by varying the overvoltage according to step d); and
f) driving the hydrogen coverage along the desired trajectory by varying the overvoltage according to step d).

26. The method of claim 1 wherein the method includes a feedback control method of operating the device using a fuel containing an electrocontaminant, the method comprising applying voltage control to an anode of the device using the following algorithm:
a) determining a mathematical model that relates the instantaneous coverage of fuel and contaminant to the overvoltage applied to the anode;
b) forming an observer that relates the instantaneous coverage of the fuel and contaminant to the measured current of the device;
c) driving the estimated contaminant coverage to a low value by varying the overvoltage; and
d) driving the estimated fuel coverage to a desired value by varying the overvoltage.

27. The method of claim 1 wherein the method includes a feedback control method of operating the device using a fuel containing an electrocontaminant, the method comprising applying voltage control to an anode of the device using the following algorithm:
a) determining a mathematical model that relates the instantaneous coverage of fuel and contaminant to the overvoltage applied to the anode;
b) forming an observer that relates the instantaneous coverage of the fuel and contaminant to the measured current of the device;
c) prescribing a desired trajectory of the instantaneous coverage of the fuel and contaminant as a function of time;
d) forming a set of mathematical relationships from steps a), b) and c) that allows the current to be measured, the overvoltage to be prescribed and the instantaneous contaminant coverage and instantaneous fuel coverage to be predicted;
e) driving the contaminant coverage along the desired trajectory by varying the overvoltage according to step d); and
f) driving the fuel coverage along the desired trajectory by varying the overvoltage according to step d).

28. The method of claim 1 wherein the electrochemical device is a fuel cell, and the method comprises applying voltage control to an anode of the fuel cell using the following algorithm:
a) determining a mathematical model that relates the instantaneous coverage of hydrogen and carbon monoxide to the measured variables of the electrode or fuel cell;
b) calculating the optimal waveform(s) of the control variable(s) to maximize a performance function, such as the fuel cell power, current or ability to follow a useful load, for a discrete set of instantaneous coverage of the hydrogen and carbon monoxide;
c) forming an observer that relates the instantaneous coverage of the hydrogen and carbon monoxide to the measured variables of the fuel cell; and
d) using the estimated coverages from c) to select the corresponding optimal waveform(s) from b) to maximize the performance function for a specified period of time.

29. The method of claim 1 wherein the electrochemical device is a fuel cell, and the method comprises the following steps:
a) determining a mathematical model that relates the instantaneous coverage of hydrogen and carbon monoxide to the measured variables, including the control variables, of the electrode or fuel cell;
b) calculating the optimal waveform(s) of the control variable(s) to maximize a performance function, such as the fuel cell power, current or ability to follow a useful load, for a discrete set of instantaneous coverage of the hydrogen and carbon monoxide;
c) forming an observer that relates the instantaneous coverage of the hydrogen and carbon monoxide to the measured variables of the fuel cell;
d) using the estimated coverages from c) to select the corresponding optimal waveform(s) from b) to maximize the performance function for a specified period of time; and
e) varying the parameters describing the waveform(s) to further maximize the performance function.

30. A method of operating a fuel cell comprising:
a) applying a time-varying amplitude of a flow of fuel or oxidant to an anode or cathode of the fuel cell, the fuel or oxidant containing a contaminant;
b) applying at least one time-varying electrical parameter to the entire fuel cell, individual cells or groups of cells, where the parameter includes at least one of current, voltage, electrode overvoltage, and impedance; and
c) using a controller to control the timing and the time-varying amplitude of the flow and the at least one electrical parameter to maximize a performance measure of the fuel cell.

31. The method of claim 30 where the contaminant is carbon monoxide with a concentration of between 100 and 100,000 parts per million.

32. The method of claim 30 where the performance measure is average power, average efficiency, average voltage or average current.

33. The method of claim 30 where the performance measure is deviation of power, efficiency, voltage, current, or a combination thereof, from a desired trajectory.

34. The method of claim 30 where the fuel cell is a polymer electrolyte fuel cell.

35. The method of claim 30 where the fuel contains hydrogen.

36. The method of claim 30 wherein the electrochemical device is a fuel cell, and the method comprises the following steps:
a) determining a mathematical model that relates the instantaneous coverage of hydrogen and carbon monoxide to the measured variables, including the control variables, of the electrode or fuel cell;
b) calculating the optimal waveform(s) of the control variable(s) to maximize a performance function, such as the fuel cell power, current or ability to follow a useful load, for a discrete set of instantaneous coverage of the hydrogen and carbon monoxide;
c) forming an observer that relates the instantaneous coverage of the hydrogen and carbon monoxide to the measured variables of the fuel cell;
d) using the estimated coverages from c) to select the corresponding optimal waveform(s) from b) to maximize the performance function for a specified period of time; and
e) varying the parameters describing the waveform(s) to further maximize the performance function.

37. The method of claim 30 further comprising an additional step d), before step c), of forming mathematical observers that relate fuel and oxidant coverage to the measured data, such as current or voltage, and wherein step c) comprises using a controller with the mathematical observers and the measurements of either or all of current and voltage to control the timing and the time-varying amplitude of the flow and at least one electrical parameter to maximize a performance measure of the fuel cell.

38. The method of claim 30 further comprising an additional step d), before step c), of forming mathematical observers that relate fuel and oxidant coverage to the measured data, such as current or voltage, and wherein step c) comprises using a controller with the mathematical observers and the measurements of either or all of current and voltage to control the timing and the time-varying amplitude of at least one electrical parameter to maximize a performance measure of the fuel cell.

39. The method of claim 30 further comprising an additional step d), before step c), of forming mathematical observers that relate fuel and oxidant coverage to the measured data, such as current or voltage, and wherein step c) comprises using a controller with the mathematical observers and the measurements of either or all of current and voltage to control the timing and the time-varying amplitude of the flow to maximize a performance measure of the fuel cell.

40. A method of operating an electrochemical device comprising:
a) applying a time-varying and amplitude-varying flow of reactants to an anode or a cathode of the device, the reactants including a reactant that causes an undesired electrochemical reaction or adsorption onto the anode or cathode;
b) applying at least one time-varying electrical parameter to the entire device, individual cells or groups of cells, where the parameter includes at least one of current, voltage, electrode overvoltage, and impedance; and
c) using a controller to control the timing and the time-varying amplitude of the flow and the at least one electrical parameter to maximize a performance measure of the electrochemical device.
